(19) United States
(12) Patent Application Publication
(10) Pub. No.: US 2014/0366010 A1
(43) Pub. Date: Dec. 11, 2014

(54) Enabling parallel websphere runtime on different computer

(71) Applicant: HUA FAN, CALABASAS, CA (US)

(72) Inventor: HUA FAN, CALABASAS, CA (US)

(21) Appl. No.: 13/914,227

(22) Filed: Jun. 10, 2013

(51) Int. Cl. G06F 9/445

(52) U.S. Cl. CPC G06F 8/65
USPC 717/169

(57) ABSTRACT

A computer implemented method, a tangible shared storage medium, and a data processing system build a runtime environment of a system. A profile manager identifies a single complete installation of the enterprise application server and constructs the required runtime environments on different general purpose computers by utilizing the files from the complete installation and the specific requirements of each runtime environment.

### CROSS REFERENCE

PATENT CITATIONS

| Cited | Filing | Publication | | |
|---|---|---|---|---|
| Patent | date | date | Applicant | Title |
| U.S. Pat. No. | May 13, | Feb. 12, | International | Enabling |
| 8,375,382 | 2009 | 2013 | Business | parallel |
| | | | Machines | websphere |
| | | | Corporation | runtime |
| | | | | versions |

NON-PATENT CITATIONS

| | |
|---|---|
| 1 | “System and Method for Managing Java Runtime Environments”, |
| | IBM Technical Disclosure bulletin, Jul. 17, 2007. |
| 2 | IBM, System and Method for Managing Java Runtime Environments, |
| | Jul. 17, 2007, ip.com prior art database, IP.com No. |
| | IPCOM000154896D, all pages. |

### BACKGROUND OF THE INVENTION

1. Field of the Invention

The present invention relates generally to the data processing field and, more specifically, to a computer implemented method, apparatus and computer program product for building multiple runtime environments of a system from single complete installation.

2. Description of the Related Art

When an enterprise application server (EAS) in a production system is built, it needs the complete enterprise application server files. Also when a system updated is needed, the fix pack installation software will upgrade each enterprise application server and cause system down time. In case the fix pack needs be reverted back, the revert action needs be done on each enterprise application server also which will cause the same system down time.

Assume, (refer to FIG. 5) that three enterprise application servers 503, 513 and 523, for example, IBM WebSphere® Application Server (WAS) version 6.1 or 7.0 or 8.0 or 8.5, are being installed on three general purpose computers 500, 510 and 520. Assume also that three different runtime environments (REs), for example, WAS profile 1, 2 and 3, exist on different enterprise application server, and that there are also three different applications deployed on the profile 1, 2 and 3, for example, 505 on profile 1; 515 on profile 2; and 525 on profile 3. Assume also that it is it required to upgrade the EAS from one version to another, for example, from IBM WebSphere® Application Server 7.0 to 7.0.0.27.

Current runtime environments require that each enterprise application server and its runtime environment are being built on top of a complete installation of enterprise application server files on same general purpose computer. Also fix pack upgrade need to upgrade the complete enterprise application server files as well as runtime environment on each server. There are no provisions to separate the runtime environments from the complete enterprise application server files, also upgrade only the complete installation of enterprise application server files when applying fix pack so that all runtime environments are upgraded which minimized the total system down time.

### BRIEF SUMMARY OF THE INVENTION

According to one embodiment of the present invention, a computer implemented method, a tangible storage medium, and a data processing system build a runtime environment of a system. A profile manager identifies a single complete installation of the enterprise application server and constructs the required runtime environments on different general purpose computers by utilizing the files from the complete installation and the specific requirement of each runtime environment.

### BRIEF DESCRIPTION OF THE DRAWINGS

FIG. 1 depicts a pictorial representation of a network of data processing systems in which illustrative embodiments may be implemented;

FIG. 2 is a block diagram of a data processing system in which illustrative embodiments may be implemented;

FIG. 3 is a block diagram illustrating the relationship of software components operating within a computer system that may implement the present invention;

FIG. 4 is a block diagram of a Java® virtual machine in accordance with an illustrative embodiment;

FIG. 5 is a current known dataflow diagram for provisioning profiles to an enterprise application server of a data processing system;

FIG. 6 is a dataflow diagram for provisioning profiles to an enterprise application server of a data processing system according to an illustrative embodiment;

FIG. 7 is a block diagram that schematically illustrates an enterprise application server file system structure according to the prior art;

FIG. 8 is a block diagram that schematically illustrates an enterprise application server file system structure according to an illustrative embodiment and

FIG. 9 is a block diagram that schematically illustrates an implementation of an illustrative embodiment.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “module” or “system.” Furthermore, the present invention may take the form of a computer program product embodied in any tangible medium of expression having computer usable program code embodied in the medium.

Any combination of one or more computer usable or computer usable medium(s) may be utilized. The computer-usable or computer-recordable medium may be, for example but is not limited to, an electronic, magnetic, optical, electromagnetic, infrared, or semiconductor system, apparatus, device, or propagation medium. In the context of this document, a computer-usable or computer-recordable medium may be any medium that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including but not limited to internet, wireless, wire-line, optical fiber cable, RF, etc.

Computer program code for carrying out operations of the present invention may be written in any combination of one or more programming languages, including an object oriented programming language such as Java®, C++ or the like and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN) or through internet, or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer (such as, but not limited to, physical server, logical hardware partition or virtual server or other programmable data processing apparatus) to produce a machine, such that the instructions, which execute via the processor of the general purpose computer, create means for implementing the functions/acts specified in the flowchart and/or block diagram block or blocks. These computer program instructions may also be stored in a computer usable medium that can direct a computer or other programmable data processing apparatus to function in a particular manner, such that the instructions stored in the computer usable medium produce an article of manufacture including instruction means which implement the function/act specified in the flowchart and/or block diagram block or blocks.

The computer program instructions may also be loaded onto a general purpose computer to cause a series of operational steps to be performed on the general purpose computer to produce a computer implemented process such that the instructions which execute on the general purpose computer provide processes for implementing the functions/acts specified in the flowchart and/or block diagram block or blocks.

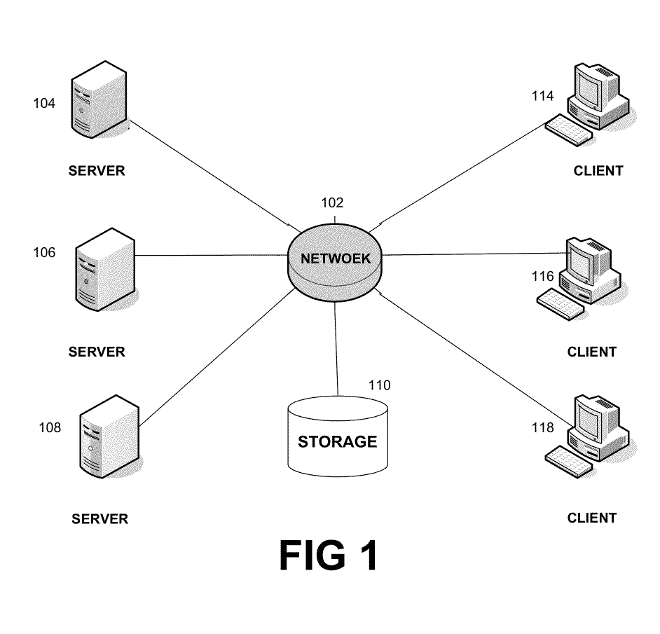

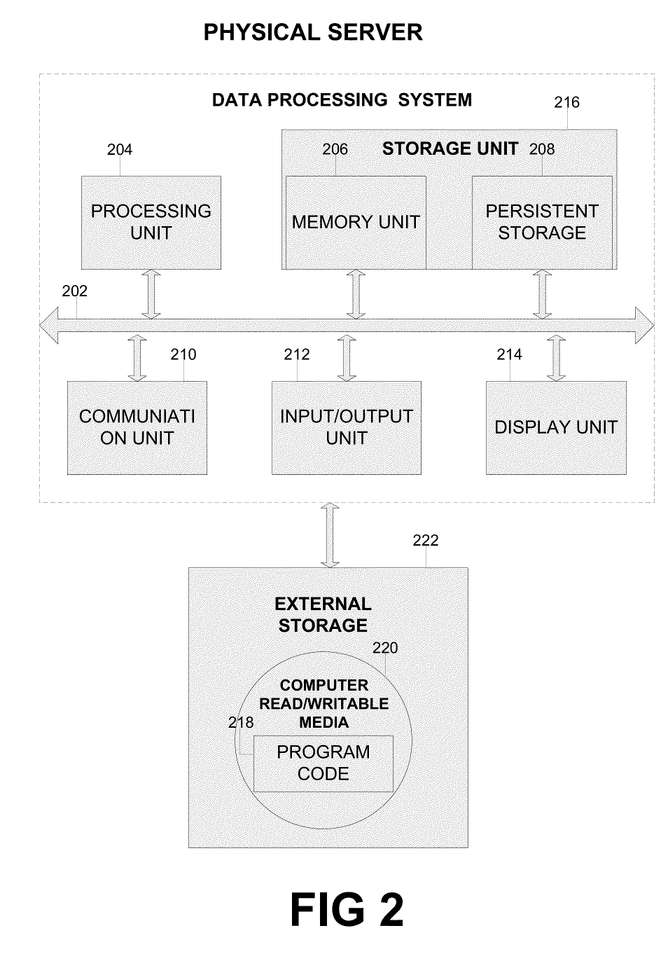

With reference now to the figures and in particular with reference to FIGS. 1 and 2, exemplary diagrams of data processing environments are provided in which illustrative embodiments may be implemented. It should be appreciated that FIGS. 1 and 2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. FIG. 1 contains network 102, which is the medium used to provide communications links between various devices and computers connected together within network data processing system. Network 102 may include connections, such as internet, wire, wireless communication links, or fiber optic cables.

In the depicted example, server 104, server 106 and server 108 connect to network 102 along with storage unit 110. In addition, clients 114, 116, and 118 connect to network 102. Clients and servers are general purpose computers. In the depicted example, any server 104,106 or 108 provides information, such as boot files, operating system images, and applications to clients 114, 116, and 118. Clients 114, 116, and 118 are clients to server 104, 106 or 108 in this example. FIG. 1 may include additional servers, clients, and other devices not shown.

Program code located in network data processing system as FIG. 1 may be stored on a computer usable storage medium and downloaded to a data processing system or other device for use. For example, program code may be stored on a computer usable storage medium on server 104 or on storage unit 110 and downloaded to client 114 over network 102 for use on client 114.

In the depicted example, network 102 representing a worldwide collection of networks and gateways that use the Transmission Control Protocol/Internet Protocol (TCP/IP) suite of protocols to communicate with one another. Of course, such a network data processing system also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. FIG. 2 is an example of a computer, such as server 104 or client 114 in FIG. 1, in which computer usable program code or instructions implementing the processes may be located for the illustrative embodiments. In this illustrative example, data processing system includes communications bus 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. Persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications bus 202. In these illustrative examples the instruction are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 218 is located in a functional form on computer usable media 220 that is selectively removable and may be loaded onto or transferred to data processing system for execution by processor unit 204. Program code 218 and computer readable media 220 form computer program product 222 in these examples. In one example, computer usable media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer usable media 218 also may take the form of a persistent storage, such as a hard drive, a SAN, or a flash memory that is connected to data processing system 200. The tangible form of computer usable media 220 is also referred to as computer usable storage media. In some instances, computer usable media 220 may not be removable.

Alternatively, program code 218 may be transferred to data processing system 200 from computer usable media 220 through a communication bus to communication unit 210 and/or through a connection to input/output unit 212. The communication link and/or the connection may be physical or wireless in the illustrative examples. The computer usable media also may take the form of non-tangible media, such as communications links or wireless transmissions containing the program code.

In some illustrative embodiments, program code 218 may be downloaded over a network or internet to persistent storage 208 from another device or data processing system for use within data processing system. For instance, program code stored in a computer usable storage medium in a server data processing system may be downloaded over a network or internet from another data processing system. The data processing system providing program code 218 may be a server computer, a client computer, or some other device capable of storing and transmitting program code 218.

The different components illustrated in FIG. 2 are not meant to provide architectural limitations to the manner in which different embodiments may be implemented. The different illustrative embodiments may he implemented in a data processing system including components in addition to or in place of those illustrated in FIG. 2. Other components shown in FIG. 2 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in FIG. 2 is any hardware apparatus that may store data. Memory 206, persistent storage 208 and computer readable media 220 are examples of storage devices in a tangible form. A storage device may provide storage space to a computer locally or remotely, such as, but not limited to, through SAN or internet.

In another example, a bus system may be used to implement communication bus 202 and may be comprised of one or more buses, such as a system bus or an input/output bus. Of course, the bus system may be implemented using any suitable type of architecture that provides for a transfer of data between different components or devices attached to the bus system, such as fiber or internet, etc. Additionally, a communication unit may include one or more devices used to transmit and receive data, such as a modem or a network adapter. Further, a memory may be, for example, memory 206 or a cache such as found in an interface and memory controller hub that may be present in communication bus 202.

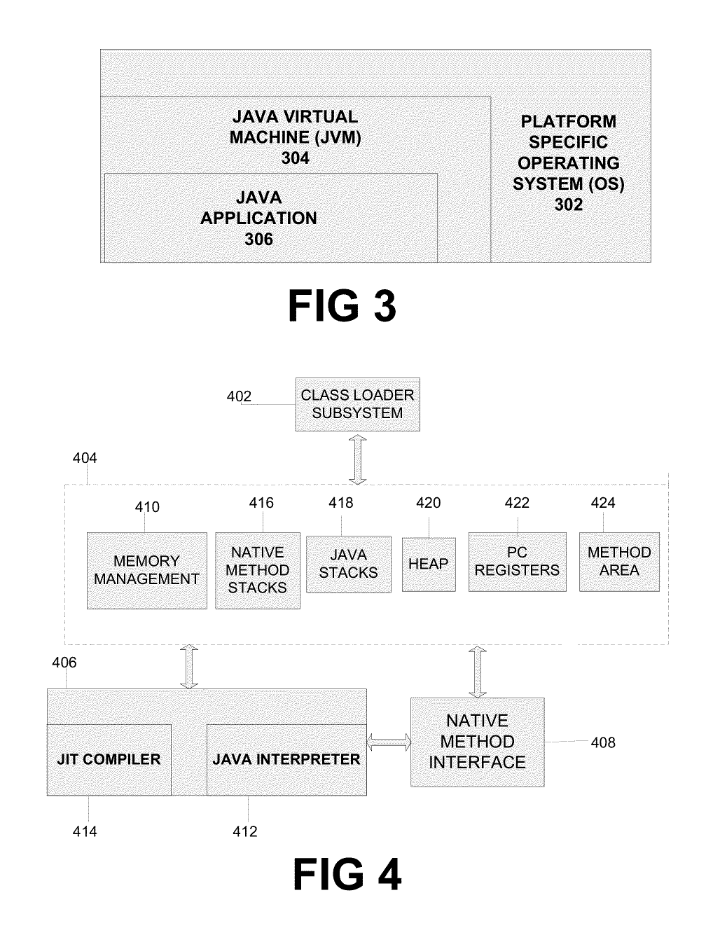

With reference now to FIG. 3, a block diagram illustrates the relationship of software components operating within a computer system that may implement the present invention. A Java®-based system contains platform specific operating system (OS) 302 that provides hardware and system support to software executing on a specific hardware platform, the Java® virtual machine (JVM) 304 that is one software application that may execute in conjunction with the operating system, which is a program or software component written in the Java® programming language and the Java® application 306. Java® virtual machine 304 provides a Java® run-time environment with the ability to execute Java® application 306. The computer system in which Java® virtual machine 304 operates may be similar to data processing system in FIG. 1 or computer in FIG. 2 described above. However, Java® virtual machine 304 may be implemented in dedicated hardware on a so-called Java® chip, Java®-on-silicon, or Java® processor with an embedded micro-Java core.

At the center of a Java® run-time environment is the Java® virtual machine, which supports all aspects of Java®'s environment, including its architecture, security features, and mobility across networks, and platform independence.

The Java® virtual machine is a virtual computer, for example, a computer that is specified abstractly. The specification defines certain features that every Java® virtual machine must implement, with some range of design choices that may depend upon the platform on which the Java® virtual machine is designed to execute. For example, all Java® virtual machines must execute Java® bytecodes and may use a range of techniques to execute the instructions represented by the bytecodes. A Java® virtual machine may be implemented completely in software or somewhat in hardware.

When an application is executed on a Java® virtual machine that is implemented in software on a platform-specific operating system, a Java® application may interact with the host operating system by invoking native methods. A Java® method is written in the Java® language, compiled bytecodes, and stored in class files. A native method is written in some other language and compiled to the native machine code of a particular processor

With reference now to FIG. 4, a block diagram of a Java® virtual machine is depicted in accordance with an illustrative embodiment. Java® virtual machine (JVM) in FIG. 4 includes class loader subsystem 402, which is a mechanism for loading types, such as classes and interfaces, given fully qualified names. Java® virtual machine also contains runtime data areas 404, execution engine 406, native method interface 408, and memory management 410. Execution engine 406 is a mechanism for executing instructions contained in the methods of classes loaded by class loader subsystem 402. Execution engine 406 may be, for example, Java® interpreter 412 or just-in-time compiler 414. Native method interface 408 allows access to resources in the underlying operating system. Native method interface 408 may be, for example, the Java® Native Interface (JNI).

Runtime data areas 404 contain native method stacks 416, Java® stacks 418, PC registers 420, method area 422, and heap 424. These different data areas represent the organization of memory needed by Java® virtual machine to execute a program.

Java® stacks 418 are used to store the state of Java® method invocations. When a new thread is launched, the Java® virtual machine creates a new Java® stack for the thread. The Java® virtual machine performs only two operations directly on Java® stacks. It pushes and pops frames. A thread's Java® stack stores the state of Java® method invocations for the thread.

Program counter (PC) registers 420 are used to indicate the next instruction to be executed. Each instantiated thread gets its own PC register and Java® stack. If the thread is executing a Java® virtual machine method, the value of the PC register indicates the next instruction to execute. If the thread is executing a native method, then the contents of the PC register are undefined.

Native method stacks 416 stores the state of invocations of native methods. The state of native method invocations is stored in an implementation-dependent way in native method stacks, registers, or other implementation-dependent memory areas. In some Java® virtual machine implementations, native method stacks 416 and Java® stacks 418 are combined.

Method area 422 contains class data while heap 424 contains all instantiated objects. The constant pool is located in method area 422 in these examples. The Java® virtual machine specification strictly defines data types and operations. Most Java® virtual machines choose to have one method area and one heap, each of which are shared by all threads running inside the Java®virtual machine. When Java® virtual machine loads a class file, it parses information about a type from the binary data contained in the class file. Java® virtual machine places this type of information into the method area. Each time a class instance or array is created, the memory for the new object is allocated from heap 424. Java® virtual machine includes an instruction that allocates memory space within the memory for heap 424 but includes no instruction for freeing that space within the memory. Memory management 410 in the depicted example manages memory space within the memory allocated to heap 424. Memory management 410 may include a garbage collector, which automatically reclaims memory used by objects that are no longer referenced. Additionally, a garbage collector also may move objects to reduce heap fragmentation.

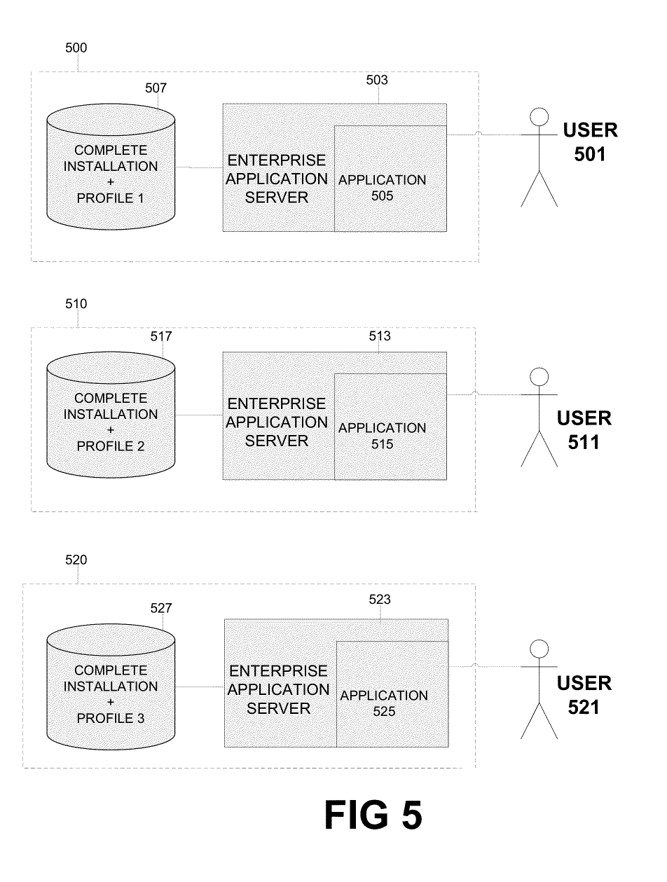

Referring now to FIG. 5, a current known dataflow diagram for provisioning profiles to an enterprise application server of a data processing system is depicted. General purpose computer 500, 510 and 520 each hosts a complete enterprise application server files and a profile. Enterprise application server 503, 513 and 523 are Java® virtual machines (JVM) such as Java® virtual machine in FIG. 4. Application 505, 515 and 525 run inside each JVM. General purpose computer 500, 510 and 520 each maintains complete enterprise application server files for the profile defined on it. Profiles provide specific configuration and runtime parameters for enterprise application server such as 503, 513 and 523.

Enterprise application server 503, 513 and 523 contain Application 505, 515 and 525. Enterprise application server 503, 513 and 523 are the primary runtime component where applications of Java® virtual machine actually execute.

Enterprise application server 503, 513 and 523 are created using one of profiles stored in profile database 507, 517 and 527. Profile database 507, 517 and 527 are data structure implemented on a storage unit, such as storage unit 110 of FIG. 1, which contains or references the location of profiles 1, 2 or 3. Profiles 1, 2 or 3 are data structures that include the files that define a runtime environment for an enterprise application server, such as a deployment manager or an application server. Each enterprise application server has its own configuration files, logs, properties, and other attributes. Profile can make each runtime of application servers unique and separate from the server binaries and from other profiles.

Each of general purpose computer 500, 510 and 520 is a complete enterprise application server installation, including any software patches and updates available at the time of which the profile is created. Each time one of profiles 1, 2 or 3 is patched or updated, the enterprise application server files and profile files are updated.

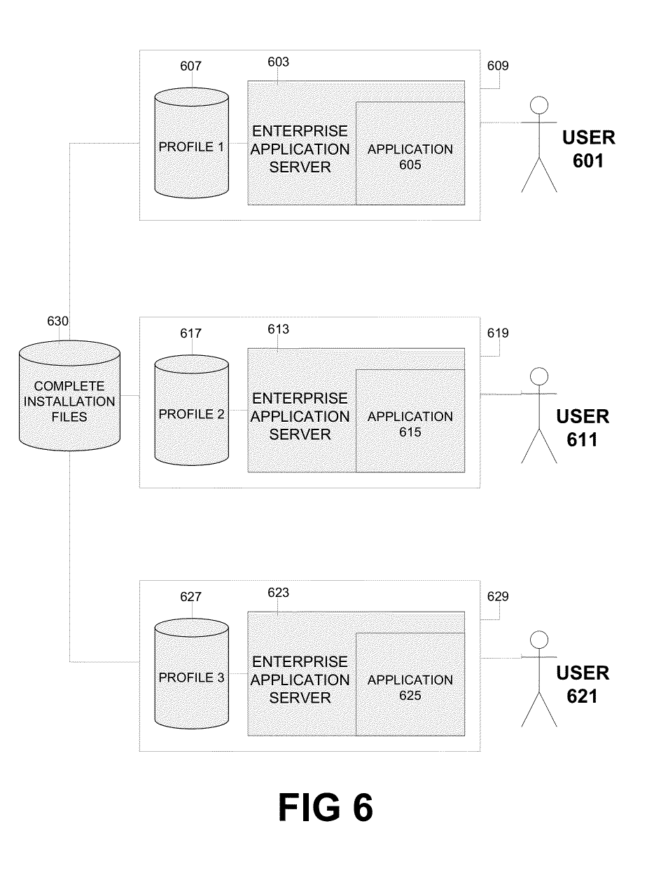

Referring now to FIG. 6, a dataflow diagram for provisioning profiles to an enterprise application server of a data processing system according to an illustrative embodiment is depicted. Shared storage unit 630 is any piece of hardware that is capable of storing information, such as, for example without limitation, data, program code in functional form, and/or other suitable information either on a temporary basis and/or a permanent basis, as 216 in FIG. 2. Shared storage unit 630 may be connected to general purpose computer 609, 619 and 629 using any appropriate medium, including but not limited to Internet, wireless, wireline, optical fiber cable, RF, etc. A complete enterprise application server files, for example, IBM WebSphere® Application Server (WAS) version 6.1 or 7.0 or 8.0 or 8.5, store on shared storage unit 630.

A complete enterprise application server files is built through a complete enterprise application server installation including any software patches and updates available at the time of the installation.

General purpose computer 609, 619 and 629 each hosts an enterprise application server. General purpose computer 609, 619 and 629 each maintains only the profile defined for the enterprise application server running on it on its storage unit 607, 617 and 627. Enterprise application server 603, 613 and 623 are Java® virtual machines (JVM) such as Java® virtual machine in FIG. 4. Enterprise application server 603, 613 and 623 are created using the complete enterprise application server files on shared storage unit 630 and one of profile 1, 2 or 3 on its own storage unit. Application 605, 615 and 625 execute inside each enterprise application server (JVM).

Profile 1, 2 or 3 include the files that define a runtime environment for an application server process, such as a deployment manager or an application server. Each runtime environment has its own configuration files, logs, properties, and other attributes. Profile 1, 2 or 3 can make each runtime environment of enterprise application servers 605, 615 and 625 unique and separate from each other profiles.

Illustrative embodiments provide a computer implemented method, system and computer program product for a separation of complete enterprise application server files from runtime environment implementation. According to an illustrative embodiment, any future software patches and updates only need to upgrade the single complete enterprise application server files on shared storage unit 630 which causes all runtime environments of enterprise application server be upgraded.

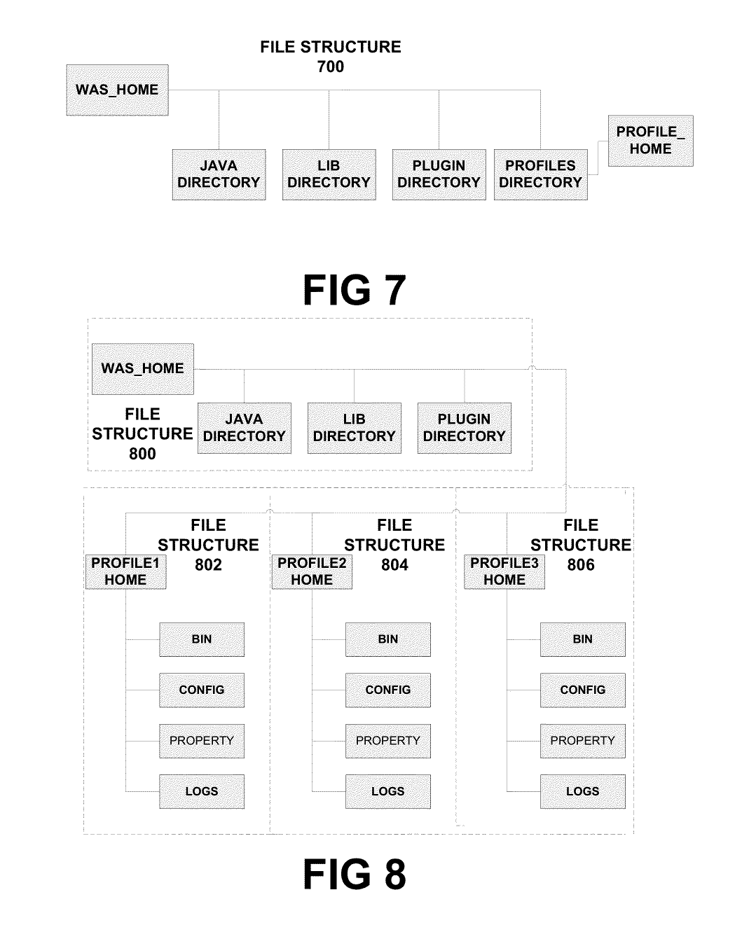

Referring now to FIG. 7, a block diagram that schematically illustrates an enterprise application server file system structure is shown according to the prior art. File structure 700 is an organization of the file system structure of the EAS so that a complete enterprise application server files and multiple other runtime files can be kept in the enterprise application server home directory. File structure 700 is a schematic representation of a file system containing complete enterprise application server files and profile, such as profile database 507, 517 and 527 in FIG. 5.

File structure 700 includes a home directory. Home directory can be, for example, but is not limited to the \WebSphere\AppServer WAS_HOME directory when the enterprise application server is a WebSphere® Application Server. The \profiles directory contains all profiles, however, the other directories and files of WebSphere, for example, Java® directory, lib directory, plugins directory and properties directory are all under the WAS_HOME level. When an upgrade to the Enterprise application server is made, for example, to upgrade from version 7.0 to version 7.0.0.27, each of the files, for example, files inside Java® directory, lib directory, plugins directory properties directory and profiles directory will all be changed to reflect the upgrade.

Referring now to FIG. 8, a block diagram that schematically illustrates an enterprise application server file system structure is shown according to an illustrative embodiment. File structure 800 is an organization of the file system structure of the Enterprise application server containing the complete enterprise application server files stored on shared storage unit, such as shared storage unit 630 in FIG. 6

File structure 802, 804 and 806 each is an organization of the file system structure of the Enterprise application server containing only profile's home directory on different general purpose computers. Profile 1, 2 or 3 include the files that define a unique runtime environment for an enterprise application server, such as a deployment manager or an application server. Each runtime environment defined under profile's home directory has its own bin directory, config directory, logs directory, property directory, and other attributes. Profile 1, 2 or 3 need be connected with file structure 800 during runtime to make the each runtime environment of enterprise application server functional. Profile 1, 2 or 3 can make each runtime environment of enterprise application server unique.

File structure 802, 804 and 806 are corresponding to the profiles 1, 2 or 3 stored on storage unit 607, 617 and 627 in FIG. 6

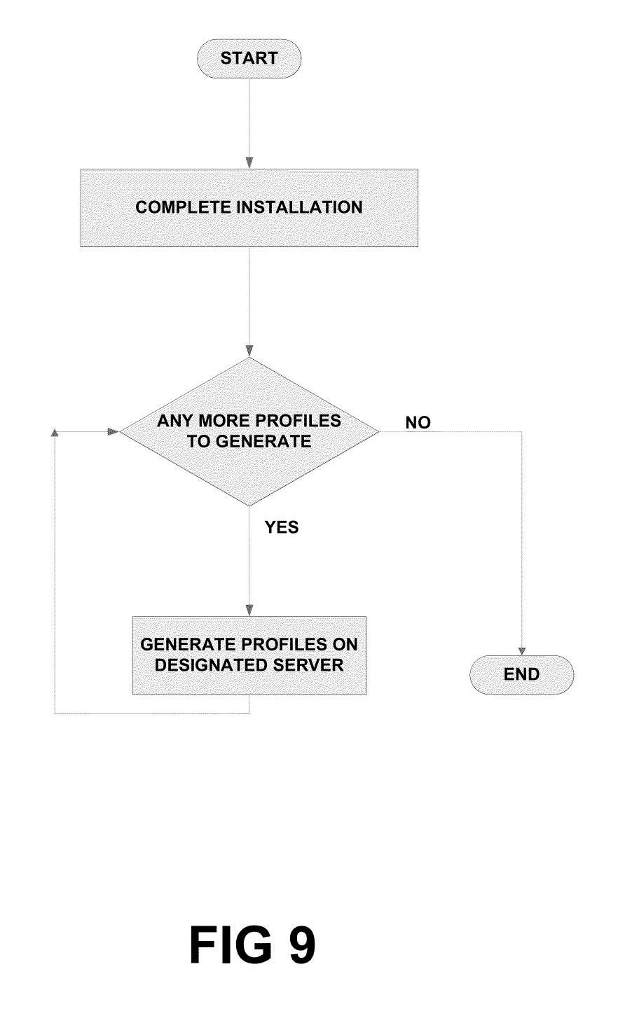

FIG. 9 is a block diagram that schematically illustrates an installation of an illustrative embodiment.

FIG. 9 shows a software process, executing on a computing environment, such as in FIG. 1. Process begins by starting the installation of a complete enterprise server files on a shared storage as storage unit 110 of FIG. 1. A determination is made whether any more profile creations are needed. If response to determining that more profile creation is needed (Yes), the process will continue to create the requested profiles on designated general purpose computer. After completion of the profile creation, the process goes back to determination point. If response to determining that no more profile creation is needed (No), the process will end successfully.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A non-transitory computer program product comprising:
a computer usable storage medium;
program code, stored on the shared computer usable storage medium, The shared computer usable storage medium contains a complete installation of the an enterprise application server files based on the requested enterprise application server and any software patches and updates available at the time of the installation.
program code, stored on the computer usable storage medium, for building the particular application server process utilizing the required profile and allocating the particular application server process within the runtime environment on each general purpose computer: The required profile is a data partition containing information associated with a complete installation of an enterprise application server files and all associated unique request files that generate the required profile on a specific general purpose computer;
and program code, stored on the computer usable storage medium, for receiving a user service request, wherein a profile is used to create a required instance of at least one software component needed to fulfill the user's service request;

2. The computer program product of claim 1, wherein the particular runtime environment comprises one of a plurality of runtime environments, each runtime environment being implemented in a separate instance of an object oriented program virtual machine on a general purpose computer.

3. The computer program product of claim 2, wherein ones of the plurality of runtime environments utilize the complete enterprise application files, such that the ones of the plurality of runtime environments have their own executable files, configuration files, logs, and properties.

4. The computer program product of claim 1, wherein the profile manager specifies the arrangement hierarchy for logically overlaying the complete installation of the enterprise application server component, and the at least one profile file structure on each general purpose computer.

5. The computer program product of claim 1, wherein the complete enterprise application server files is a complete installation of an enterprise application server, including any software patches and updates available at the time of the installation, resided on shared computer usable storage medium.

6. A data processing system comprising:
a storage unit having instructions for building a runtime environment on a physical computer;
a connecting system connecting the storage unit to a processor; and
a processor, wherein the processor executes the instructions to receive a service request containing specific request for a profile, to create a required instance of at least one software component needed to fulfill the service request, wherein the required instance of the runtime environment connects to a complete installed version of an enterprise application server on a shared storage and specific profile's files; wherein the specific profile is a data partition containing information associated with a complete installation of enterprise application server files and all unique request files associated with one profile that update the required profile to dynamically construct a runtime environment.

7. The data processing system of claim 6, wherein the profile files further comprises a link to the complete installation enterprise application server files and all associated unique request files that generate the required profile on a specific general purpose computer, wherein the processor executing the instructions to dynamically construct a runtime environment by preferentially utilizing files from the at least one profile's files followed by files from the complete installation further comprises the processor executing the instructions:
To apply any software patches and updates only needs to apply all changes to files and directories in the complete installation of enterprise application server files.

8. The data processing system of claim 6, wherein the particular runtime environment comprises one of a plurality of runtime environments, each runtime environment being implemented in a separate instance of an object oriented program virtual machine on a general purpose computer.

9. The data processing system of claim 6, wherein ones of the plurality of runtime environments utilize at least one profile file, such that the ones of the plurality of runtime environments have their own configuration files, logs, and properties.

10. The data processing system of claim 6, wherein the profile manager specifies the arrangement hierarchy for logically overlaying the complete installation of the enterprise application server component, and the at least one profile file structure on each general purpose computer

11. The data processing system of claim 6, wherein the complete enterprise application server files is a complete installation of an enterprise application server resided on shared computer usable storage medium
